(19) United States
(12) Patent Application Publication
(10) Pub. No.: US 2013/0263456 A1
(43) Pub. Date: Oct. 10, 2013

(54) CUTTING ACCESSORY AND AN OSCILLATING POWER TOOL USING THE CUTTING ACCESSORY

(71) Applicants: Hongfeng Zhong, Suzhou (CN); Lixiang Huo, Suzhou (CN); Haiquan Wu, Suzhou (CN); Shisong Zhang, Suzhou (CN)

(72) Inventors: Hongfeng Zhong, Suzhou (CN); Lixiang Huo, Suzhou (CN); Haiquan Wu, Suzhou (CN); Shisong Zhang, Suzhou (CN)

(73) Assignee: POSITEC POWER TOOLS (SUZHOU) CO., LTD., Suzhou, Jiangsu (CN)

(21) Appl. No.: 13/994,693

(22) PCT Filed: Dec. 15, 2011
(86) PCT No.: PCT/CN2011/084036

§ 371 Date: Jun. 14, 2013

(30) Foreign Application Priority Data
Dec. 15, 2010 (CN) 201010596890.9
Dec. 15, 2010 (CN) 201010596902.8
Dec. 15, 2010 (CN) 201010596908.5

(51) Int. Cl. B26B 15/00

(52) U.S. Cl. CPC B26B 15/00
USPC 30/173

(57) ABSTRACT

A cutting accessory detachably mounted on an oscillating power tool is disclosed. The oscillating power tool includes a head housing and an output shaft extending from the head housing. The output shaft rotates oscillatingly about a longitudinal axis thereof. The cutting accessory includes a housing adapted to the head housing, two movable blades partly received in the housing, and a driving element adapted to the output shaft. The driving element is configured to oscillate by the actuation of the output shaft and simultaneously drives the two movable blades to move in the opposite directions to cut a workpiece.

### TECHNICAL FIELD

The present invention relates to an accessory of a power tool, in particular to a cutting accessory detachably mounted on an oscillating power tool. The present invention also relates to an oscillating power tool using the cutting accessory.

### BACKGROUND OF THE INVENTION

An Oscillation tool is a common oscillating power tool. Its output shaft rotates and swings around the axis, so with different accessory tool bits installed on the output shaft, many different operation functions can be realized, such as sawing, cutting, grinding and scraping, thus meeting different working demands.

However, many oscillation tools do not currently have a special accessory tool bit for realizing shearing and cutting operations, and if they use the existing accessory tool bit, such as the saw blade, they achieve an undesirable cutting effect. Therefore, other tools, such as electric scissors, are required to meet the shearing and cutting demands of the user.

At present, common electric scissors comprise two knives, one of which usually is a fixed knife, while the other is a moving knife which moves relative to the fixed knife. The moving knife is connected with the transmission shaft and can generate reciprocating oscillation by the action of the motor, while the fixed knife is kept still. Thus, by means of the reciprocating movement of the moving knife, the shearing and cutting functions of the scissors are realized.

In the field, a cutting accessory capable of being applied to the oscillating power tool is needed to expand the application scope of the oscillation tool. To meet this demand, a publicized German patent application DE102008030024A1 discloses a cutting accessory capable of being applied to the oscillation tool. The structure of this cutting accessory is similar to that of the electric scissors, also comprising a fixed knife and a moving knife driven by the output shaft of the oscillation tool to oscillate reciprocatingly.

However, when the cutting accessory applied to the oscillating power tool cuts an object, only the moving knife imposes a cutting force onto the object, so the cutting force is not enough and the cutting efficiency is low.

Thus, it is truly necessary to provide an improved cutting accessory to overcome the shortcomings of the cutting accessory applied to the oscillating power tool.

### SUMMARY OF THE INVENTION

The object of the invention is to disclose a cutting accessory which is capable to detachably mount on an oscillating power tool and has an improved efficiency.

A cutting accessory detachably mounted on an oscillating power tool, the oscillating power tool includes a head housing and an output shaft extending from the head housing. The output shaft reciprocatingly rotates along the axis of the output shaft. The cutting accessory includes a housing adapted to the head housing, two movable blades partly received in the housing, and a driving element adapted to the output shaft. The driving element reciprocatingly rotates driven by the output shaft and simultaneously drive the two moving knives moving in the opposite directions to cut a workpiece.

In a preferred embodiment, the driving element includes a mounting portion adapted to the output shaft and two driving portions symmetrically disposed relative the mounting portion. The two driving portions adapt to the two movable blades respectively.

In a preferred embodiment, in each pair of one driving portions of the driving element and one movable blade, one of the driving portion and the movable blade includes a groove and the other includes a roller configured to be received and rolled in the groove.

In a preferred embodiment, each groove includes two straight sections which are located in the middle part of the groove and are parallel to each other.

In a preferred embodiment, the angle of the straight sections of one of the grooves relative to the line of the centers of the grooves is different from the angle of the straight sections of the other groove relative to the line of the centers of the grooves.

In a preferred embodiment, the grooves are formed at the driving portions respectively, and the centers of the two grooves and the center of mounting portion are located in a line.

In a preferred embodiment, the two movable blades pivotably connect to the same pivoting shaft. The axis of the pivoting shaft is substantially parallel to the longitudinal axis of the output shaft.

In a preferred embodiment, the centers of the rollers are equidistant from the center of the pivoting shaft.

In a preferred embodiment, the housing includes an upper cover and a lower cover adapted to the upper cover. The driving element and two movable blades disposed between the upper cover and the lower cover.

In a preferred embodiment, the housing includes an opening and a fixing portion adapted to the head housing. The output shaft configured to pass through the opening.

In a preferred embodiment, the housing includes a slot configured for receiving the driving element, and the driving element configured to rotate oscillatingly in the slot

In a preferred embodiment, the two movable blades each include a head portion, a cutting portion and a connecting portion between the head portion and the cutting portion. The head portions cooperate with the driving element respectively. The connecting portions pivotably connect to the housing. The driving element is configured to drive the cutting portions of the movable blades to move in the opposite directions.

In a preferred embodiment, the cutting accessory further includes a guide element fixed with the head housing. The movable blades each includes a head portion cooperating with the driving element, a cutting portion and a guiding portion cooperating with the guide element. The cutting portions each have cutting teeth. The cutting teeth of the cutting portion of one of the movable blades are opposite to the cutting teeth of the cutting portion of the other movable blade. The driving element is configured to drive the two movable blades to move in the opposite directions by the engagement of the guide element and the guide portion.

In a preferred embodiment, the plane defined by the two movable blades is substantially perpendicular to the longitudinal axis of the output shaft and the cutting portions of the movable blades each include the cutting teeth at both sides thereof.

Another object of the invention is providing an oscillating power tool having capable of cutting and improved cutting efficiency.

To achieve the object, the solution of the invention is as below: An oscillating power tool includes a head housing, an output shaft protruding out of the head housing and a cutting accessory mounted on the output shaft. The output shaft rotates oscillatingly about a longitudinal axis thereof. The cutting accessory includes two movable blades which move relative to the head housing, and a driving element adapted to the output shaft. The driving element is configured to oscillate by the actuation of the output shaft and to simultaneously drive the two movable blades to move in opposite directions to cut a workpiece.

To achieve the object, another solution of the invention is as below: An oscillating power tool includes a head housing, an output shaft protruding out of the head housing and a cutting accessory mounted on the output shaft. The output shaft rotates oscillatingly about a longitudinal axis thereof. The cutting accessory includes a housing adapted to the head housing, two movable blades partly received in the housing and a driving element adapted to the output shaft. The two movable blades both have head portions, cutting portions and connecting portions between the head portions and the cutting portions. The two head portions cooperate with the driving element respectively. The two connecting portion pivotably connect to the housing and the driving element drive the two movable blades to move in the opposite directions.

To achieve the object, another solution of the invention is as below: An oscillating power tool includes a head housing, an output shaft protruding out of the head housing and a cutting accessory mounted on the output shaft. The output shaft rotates oscillatingly about a longitudinal axis thereof. The cutting accessory includes a driving element adapted to the output shaft, two movable blades extending longitudinal and a guide portion adapted to the guide element. The cutting portions are both disposed of corresponding cutting teeth, the driving element drives the two movable blades to move in the opposite directions by the guide element.

The advantage of the invention is: the cutting accessory is capable of detachably mounting on an oscillating power tool, the two movable blades move in the opposite direction driven by the driving element to realize cutting movements, the two movable blades are both capable of imposing cutting force on the cutting object for improving cutting efficiency.

### BRIEF DESCRIPTION OF THE DRAWINGS

FIG. 1 is a solid view of an oscillating power tool mounted on a cutting accessory in a preferred embodiment.

FIG. 2 is a solid view in another direction of the oscillating power tool shown in FIG. 1.

FIG. 3 is an illustration of part of structure of the oscillating power tool shown in FIG. 1.

FIG. 4 is a solid view of the cutting accessory shown in FIG. 1 (in face).

FIG. 5 is a solid view of the cutting accessory shown in FIG. 1 (in back).

FIG. 6 is a solid exploded view of the cutting accessory shown in FIG. 3.

FIG. 7 is a solid exploded view in another direction of the cutting accessory shown in FIG. 3

FIG. 8 is an illustration of structure of the cutting accessory shown FIG. 3 released the cover.

FIG. 9 is a using status illustration of the cutting accessory shown in FIG. 4, which the angle of the two moving knives is α1.

FIG. 10 is a using status illustration of the cutting accessory shown in FIG. 4, which the angle of the two moving knives is α2.

FIG. 11 is a using status illustration of the cutting accessory shown in FIG. 4, which the angle of the two moving knives is α3.

FIG. 12 is a solid view of an oscillating power tool in a second embodiment.

FIG. 13 is a solid exploded view of the oscillating power tool shown in FIG. 12.

FIG. 14 is a solid exploded view in another direction of the oscillating power tool shown in FIG. 12.

FIG. 15 is a using status illustration of the cutting accessory shown in FIG. 12, which the driving element is in a horizontal position.

FIG. 16 is a using status illustration of the cutting accessory shown in FIG. 12, which the driving element rotate to an ultimate position in clockwise.

FIG. 17 is a using status illustration of the cutting accessory shown in FIG. 12, which the driving element rotate to an ultimate position in counterclockwise.

### DETAILED DESCRIPTION OF THE INVENTION

The present invention is further described in detail with reference to the attached drawings and the specific embodiments.

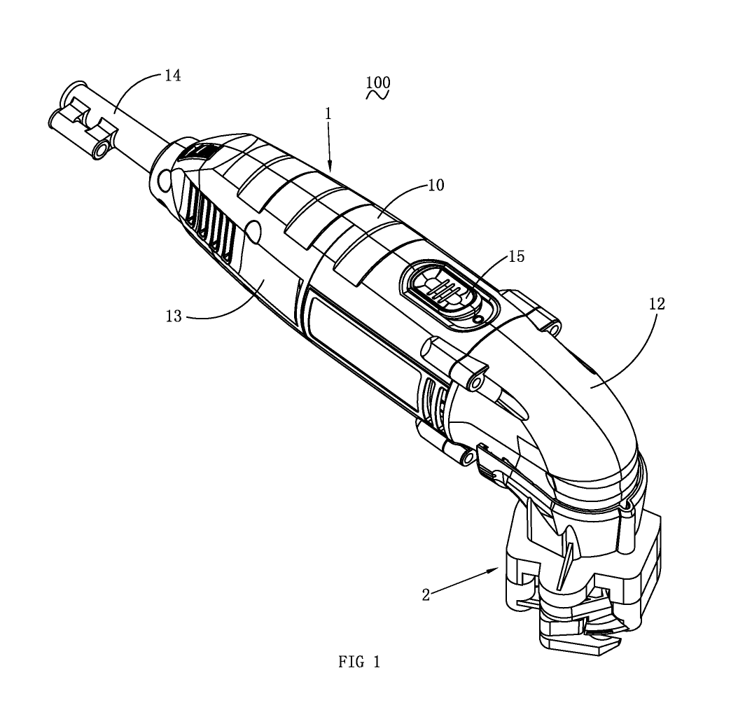

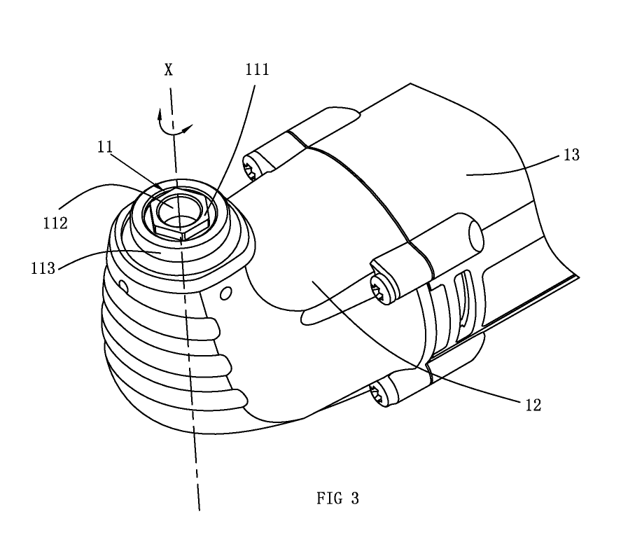

First, the first embodiment of the present invention is described in detail with references from FIG. 1 to FIG. 11.

See FIGS. 1 to 3. The first embodiment of the present invention provides an oscillating power tool 100, comprising an oscillation body 1 and a cutting accessory 2 installed on the body 1. The body 1 drives the cutting accessory 2 to realize a shearing function similar to that of the scissors, capable of being used to shear articles such as thin iron sheets and blankets.

In the full text of the description, the right side of the oscillating power tool 100 as shown in FIG. 1 is defined as “front”, and the left side “rear”. The body 1 comprises a housing 10, a motor (not shown in the figure) and a transmission mechanism (not shown in the figure) that are received in the housing 10, and an output shaft 11 driven by the transmission mechanism. Wherein, the housing 10 extending along the lengthwise direction comprises a head housing 12 located in the front portion of the body 1 and a flange plate 13 located in the rear portion of the head housing 10. The motor is arranged in the flange plate 13. The transmission mechanism is arranged in the head housing 12. The motor shaft extends forward to be adapted to the transmission mechanism. The transmission mechanism converts the rotation motion output by the motor shaft into the reciprocating rotation motion of the output shaft 11 around its own X-axis. The cutting accessory 2 is arranged below the head housing 12 of the body 1, approximately parallel to the flange plate 13 of the body 1, and is axially connected to the output shaft 11 through a fastener 3.

The body 1 also comprises a cable 14 connected to the rear portion of the flange plate 13 and providing power for the motor, and a switch 15 controlling the power transmission. When the switch 15 is turned on, the motor drives the cutting accessory 2 to cut; when the switch 15 is turned off, the motor stops rotation, and then the cutting accessory 2 stops working.

The head housing 12 is approximately “L” shaped, with one end connected to the flange plate 13 and the other end approximately shaped as an increasingly contracting circular truncated cone. The output shaft 11 is received in the head housing 12, with one end adapted to said transmission mechanism and the other end extending outwards from the free end of the head housing 12; and the extension direction of the output shaft 11 approximately vertical to that of the flange plate 13. The tail end of the output shaft 11 is provided with an orthohexagonal casing 111. The middle portion of the casing 111 is provided with a thread hole 112 for receiving and fixing the fastener 3. The free end of the output shaft 11 is also provided with a ring-shaped flange 113 around the casing 111. The upper surface of the flange 113 is lower than that of the casing 111 so as to radially support the cutting tool 2.

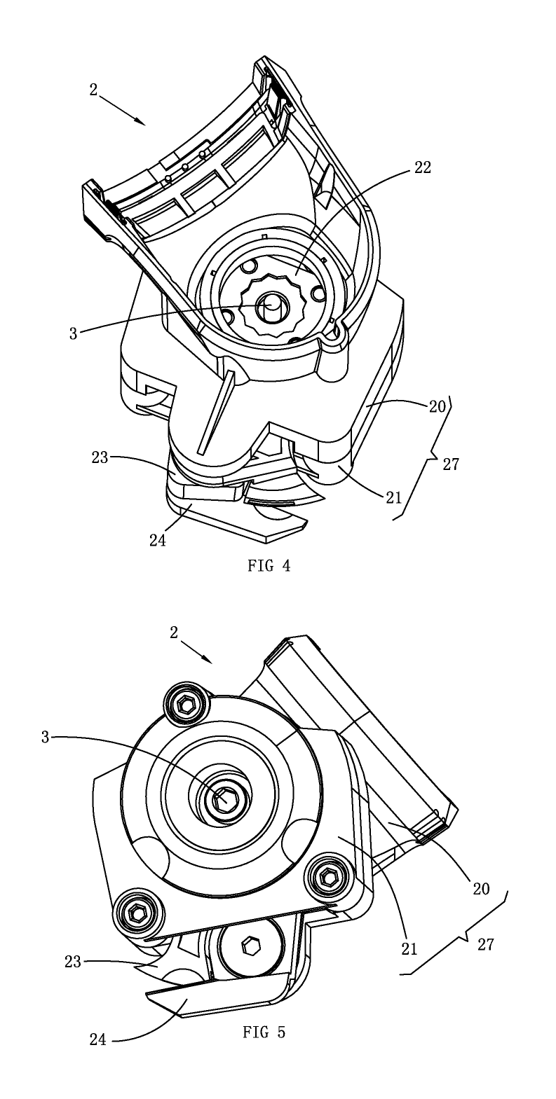

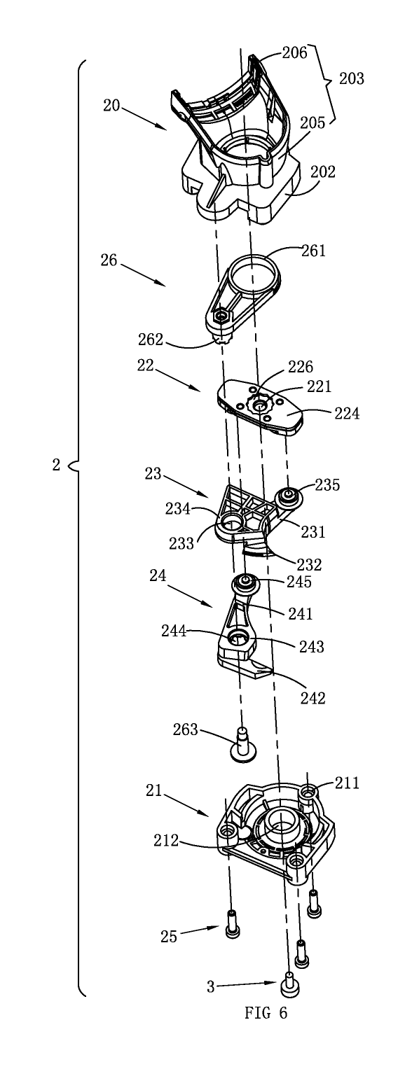

See FIG. 4 and FIG. 5. In this embodiment, the cutting accessory 2 and the body 1 are detachably and separately designed. The cutting accessory 2, as an independent accessory, is installed on the body 1 through the fastener 3. The cutting accessory 2 comprises a housing 27, a driving element 22 received in the housing 27, a first moving knife 23 and a second moving knife 24 partly extending out of the housing 27. In this embodiment, the housing 27 comprises an upper cover 20 and a lower cover 21 adapted to the upper cover 20. The driving element 22, the first moving knife 23 and a second moving knife 24 are respectively received in the space formed by the upper cover 20 and the lower cover 21. The first moving knife 23 and a second moving knife 24 are connected to the two ends of the driving elements 22. The first moving knife 23 and a second moving knife 24 are crossly pivoted together and are arranged pivotally relative to the upper cover 20. With the cutting accessory 2 installed on the body 1, when the body 1 works, the motor drives the output shaft 11 to reciprocatingly rotate so as to drive the driving element 22 adapted to the output shaft 11 to reciprocatingly rotate, and then the driving element 22 drives the first moving knife 23 and the second moving knife 24 to relatively and reciprocatingly rotate so as to realize the cutting function.

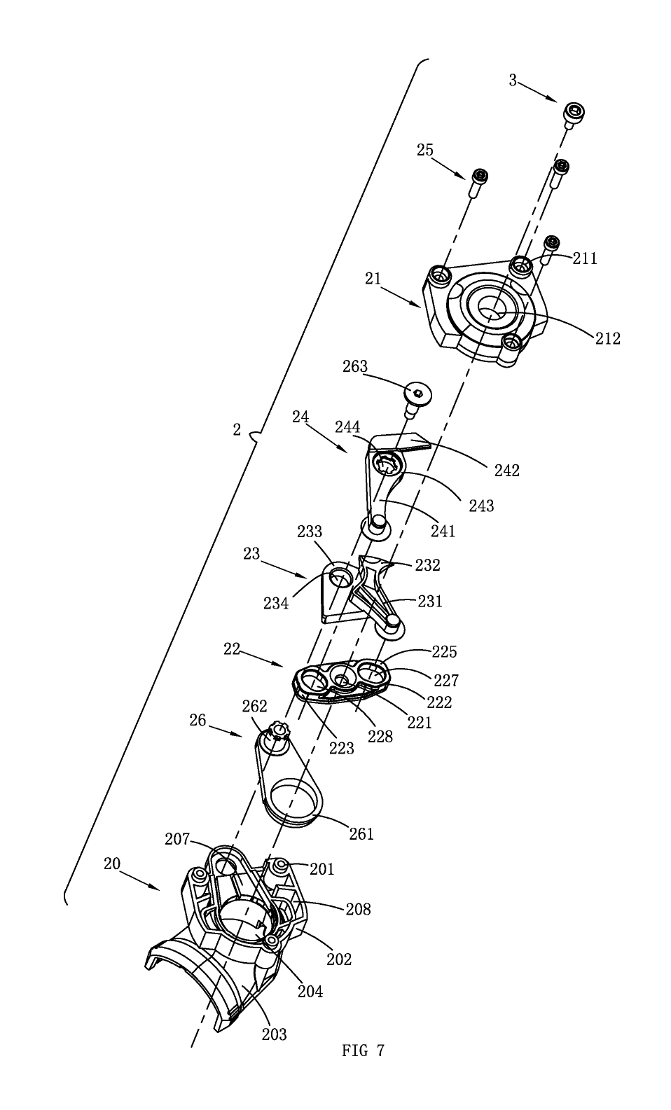

See FIG. 6 and FIG. 7. The structure of the cutting accessory 2 will be described in detail. Wherein, the upper and lower covers 20, 21 both are made from plastic materials through injection molding. The lower cover 21 is approximately square shaped, and the edges on four sides thereof are uniformly formed with three throughholes 211; while the upper cover 20 is formed with three thread holes 201 corresponding to said throughholes 211. Three bolts 25 respectively penetrate through the three throughholes 211 of the lower cover 21 into the three thread holes 201 of the upper cover 20 so as to fix the lower cover 21 and the upper cover 20 together.

The upper cover 20 is hollow, comprising an approximately square base 202 and a fixed portion 203 connected to the base 202. The plane where the base 202 exists is vertical to the X-axis of the output shaft 11, and the middle portion is provided with a round opening 204. The shape of the fixing portion 203 is approximately similar to that of said head housing 12 and can just be in tight fit with the head housing 12. The fixing portion 203 is formed by extending from one side of the base 202 to the output shaft 11, comprising a hollow, cylindrical receiving portion 205 surrounding the opening 204 and a “U” shaped fixing section 206 formed by extending from one side of the receiving portion 205 to the flange plate 13. In this way, the fixing portion 203 can be coated on the lower side of the head housing 12. By the common action of the receiving portion 205 and the fixing section 206, the cutting accessory 2 can be conveniently and quickly installed on the body 1 and is not easily moved while working.

The upper cover 20 is also equipped with a metal reinforcement 26. The reinforcement 26 is a narrow strip; one end thereof is provided with an annular sleeve 261 extending into the opening 204 of the upper cover 20, while the other end is provided with a pivoting shaft 262 extending downwards along the lower cover 21 along the X-axis of the output shaft 11, which means that the axis of the pivoting shaft 262 is parallel to the X-axis of the output shaft 11. Wherein, the inner diameter of the sleeve 261 is equivalent to the outer diameter of the flange 113 on the output shaft 11 such that the flange 113 can be completely received in the sleeve 261, which means that the two are in tight contact. To install the reinforcement 26, the bottom of the upper cover 20 is provided with a first groove 207 adapted to the shape of the reinforcement 26 towards the lower cover 21. The pivoting shaft 262 is shaped as a hollow cylinder. Said first moving knife 23 and said second moving knife 24 are crossly arranged on the pivoting shaft 262 and can pivot relative to each other around the pivoting shaft 262. The reinforcement 26 also comprises a screw 263 received in the pivoting shaft 262 for axially fixing the first moving knife 23 and the second moving knife 24.

The lower cover 21 is installed on the base 202 of the upper cover 20, so the driving element 22, the first moving knife 23 and the second moving knife 24 are received in the space formed by the upper and lower covers 20, 21. Through installing the lower cover 21, on one hand, the structure of the whole cutting accessory 2 is more stable and compact, and on the other hand, it performs dust prevention to guard the driving element 22 and the two moving knives 23, 24 in the space against dust. The lower cover 21 is similar to the shape of the base 202 of the upper cover 20, and the middle portion thereof is provided with a hole 212 corresponding to the opening 204 of the upper cover 20. The inner diameter of the hole 212 is bigger than the maximum outer diameter of the fastener 3 such that the fastener 3 can pass through the hole 212 of the lower cover 21 to be adapted to the driving element 22.

The two moving knives 23, 24 are approximately “L” shaped, crossly pivoted on the pivoting shaft 262 of the reinforcement 26, and both are made of metal. The first moving knife 23 has a first head portion 231, a first cutting portion 232 arranged opposite to the first head portion 231, and a first connecting portion 233 located between the first head portion 231 and the first cutting portion 232, and the first connecting portion 233 is provided with a first bore 234; correspondingly, the second moving knife 24 has a second head portion 241, a second cutting portion 242 arranged opposite to the second head portion 241, and a second connecting portion 243 located between the second head portion 241 and the second cutting portion 242, and the second connecting portion 243 is provided with a second bore 244. The first moving knife 23 and the second moving knife 24 respectively pass through the first bore 234 and the second bore 244 and then are sleeved on the pivoting shaft 262 of the reinforcement 26 in turn and cascaded together; moreover, the first cutting portion 232 and the second cutting portion 242 extend out of the housing 27 for convenient cutting. In addition, to be adapted to the driving element 22, the first moving knife 23 is provided with a first roller 235 installed on the free end of the first head portion 231, and the second moving knife 23 is provided with a second roller 245 installed on the free end of the second head portion 241. To facilitate cutting, the included angles formed between the head portions of the two moving knives and the cutting portion are different. In this embodiment, the included angle between the first head portion 231 of the first moving knife 23 and the first cutting portion 232 is an approximately right angle, while the included angle between the second head portion 241 of the second moving knife 24 and the second cutting portion 242 is an approximately obtuse angle. The first cutting portion 232 and the second cutting portion 242 form an opening at a certain angle. During cutting, an object can first enter the opening between the first cutting portion 232 and the second cutting portion 242, thus the object can be cut conveniently.

The driving element 22 is adapted to the output shaft 11 and driven by the output shaft 11 to actuate the two cutting knives 23, 24 to reciprocatingly rotate so as to realize cutting operation. The side, facing the lower cover 21, of the upper cover 20 is provided with a second groove 208 for receiving the driving element 22. The second groove 208 is vertically crossed with the first groove 207. The shape of the second groove 208 is similar to the driving element 22, but bigger than the driving element 22, so the driving element 22 can reciprocatingly rotate around the X-axis of the output shaft 11 by a certain angle in the second groove 208 and avoid mutual interference. The driving element 22 is made of metal, approximately oval; the middle portion is provided with a throughhole 221 through which the fastener 3 passes; and the two ends are symmetrically provided with a first driving portion 222 and a second driving portion 223. The driving element 22 has a first side face 224 facing the upper cover 20 and a second side face 225 facing the lower cover 21, wherein, the first side face 224 is provided with a mounting portion 226 adapted to the casing 111 of the output shaft 11; the mounting portion 226 is a dodecagonal recess; the second side face 225 is provided with a first groove 227 and a second groove 228 which are respectively located on the first driving portion 222 and the second driving portion 223. The mounting portion 226 is located in the centre of the driving element 22, and the throughhole 221 passes through the mounting portion 226 from the right centre. The first groove 227 is used for receiving the first roller 235 of the first moving knife 23, and the second groove 228 is used for receiving the second roller 245 of the second moving knife 24. The first groove 227 and the second groove 228 both are long-waist shaped and identical in size. The first roller 235 and the second roller 245 can respectively slide in the first groove 227 and the second groove 228.

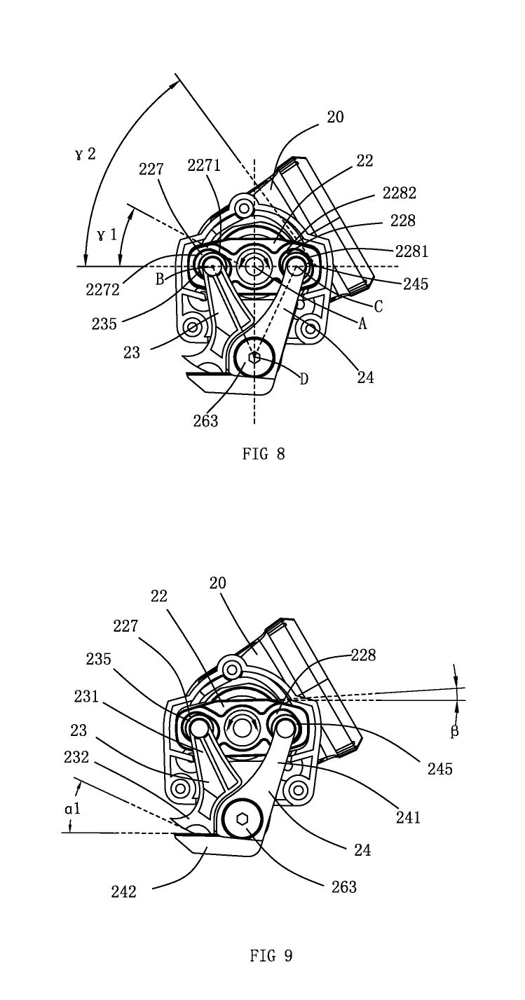

As shown in FIG. 8, the centre of the driving element 2 is A; moreover, in the state as shown in this figure, the centers of the first groove 227 and the first roller 235 are superimposed at B; the centers of the second groove 228 and the second roller 245 are superimposed at C; and the centre of the pivoting shaft 262 is D. The first groove 227 comprises two first straight sections 2271 located in the middle portion in parallel and the first arc sections 2272 symmetrically located at the two ends. Correspondingly, the second groove 228 comprises two second straight sections 2281 located in the middle portion in parallel and second arc section 2282 symmetrically located at two ends. The included angle between the first straight section 2271 and the central line BC of the first groove 227 and the second groove 228 is γ1, and the included angle between the second straight section 2281 and the central line BC of the first groove 227 and the second groove 228 is γ2. In addition, the distances from the centers of the first roller 235 and the second roller 245 to the centre of the pivoting shaft 262 are equal, namely BD=CD, so the two moving knives 23, 24 can synchronously rotate while working, thereby improving the cutting efficiency.

In this embodiment, the assembly process of the cutting accessory 2 is as follows: first, install the reinforcement 26 in the first slot 207 of the upper cover 20, in which the pivoting shaft 262 faces the lower cover 21; next, press the driving element 22 on the reinforcement 26 and place in the second slot 208 of the upper cover 20; then, cascade and sleeve the first moving knife 23 and the second moving knife 24 on the pivoting shaft 26 of the reinforcement 26 in turn, receive and fix the screw 263 in the pivoting shaft 262; next, receive the first roller 235 of the first moving knife 23 in the first groove 227 of the driving element 22, receive the second roller 245 of the second moving knife 24 in the second groove 228 of the driving element; at last, fasten the lower cover 21 on the upper cover 20, and fix the upper and lower covers 20 and 21 together through three bolts 25. Through the above steps, the assembly of the cutting accessory 2 is completed. During use, the cutting accessory 2 is adapted to and fixed on the head housing 12 of the body 1; the fastener 3 passes through the hole 212 of the lower cover 21 and the throughole 221 of the driving element 22 and is connected into the thread hole 112 of the output shaft 2 so as to axially fix the driving element 22 relative to output shaft 11, so the cutting accessory 2 is fixed with the body 1 and driven by the body 1 to realize the cutting function.

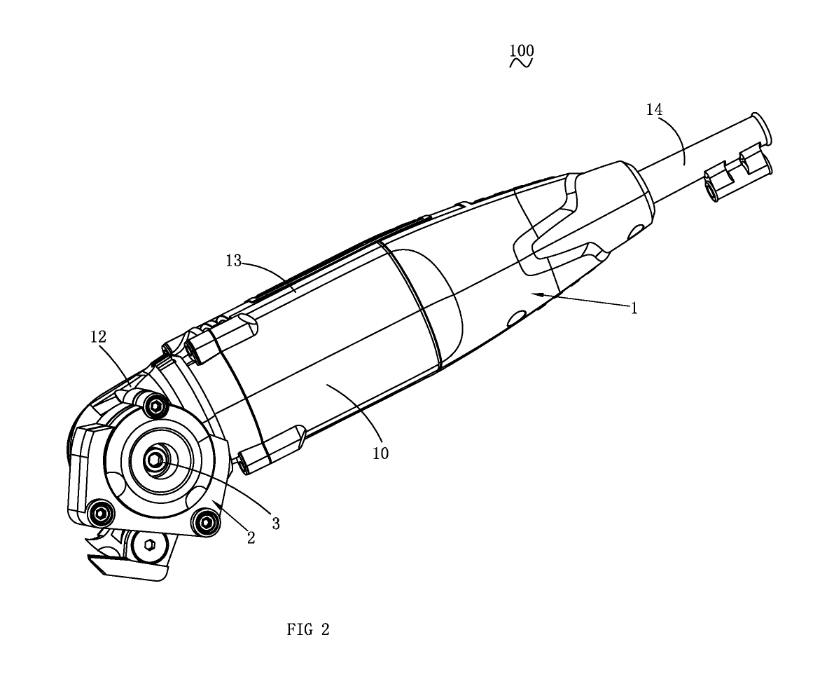

The following is a detailed description of the cutting principle of the cutting accessory 2 with reference to the FIGS. 2, 5, 9 to 11. The mounting portion 226 of the driving element 22 is adapted to the casing 111 of the output shaft 11. The first roller 235 on the first head portion 231 of the first moving knife 23 is received in the first groove 227 of the driving element 22. The second roller 245 on the second head portion 241 of the second moving knife 24 is received in the second groove 228 of the driving element 22. The first moving knife 23 and the second moving knife 24 are pivotally, crossly sleeved on the pivoting shaft 262 of the reinforcement 26, and axially limited through the screw 263.

When the oscillating power tool 100 works, the motor shaft of the body 1 drivers the output shaft 11 through the transmission mechanism to reciprocatingly rotate, and then the output shaft 11 drives the driving element 22 to reciprocatingly rotate through the fit between the casing 111 and the mounting portion 226 of the driving element 22. The sizes of the first groove 227 and the second groove 228 of the driving element 22 are respectively approximately equivalent to those of the first roller 235 corresponding to the first moving knife 23 and the second roller 245 corresponding to the second moving knife 24. The first roller 235 and the second roller 245 can rotate in the corresponding first slot 227 and second slot 228 and meanwhile can slide relative to the inside walls of the first slot 227 and the second slot 228.

In this embodiment, the oscillating angle of the output shaft 11 of the oscillating power tool 100 is 2β, namely the value of the angle between the clockwise oscillating limit position and the anticlockwise oscillating limit position of the output shaft 11, wherein 2β=0.5°-10°, which means that the oscillating frequency of the output shaft 11 is 500-250,000 times/min Obviously, the oscillating angle and oscillating frequency of the oscillating power tool 100 in the present invention are not limited in the above scope, and may be other numerical values.

As shown in FIG. 9, the output shaft 11 drives the driving element 22 to anticlockwise oscillate to the limit position. At this moment, the included angle between the first cutting portion 232 of the first moving knife 23 and the second cutting portion 242 of the second moving knife 24 is α1.

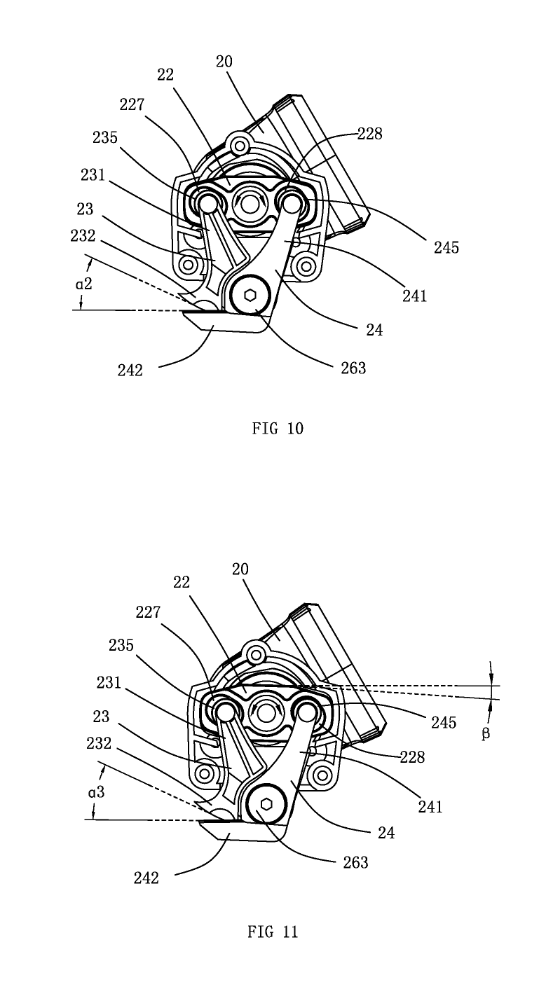

As shown in FIG. 10, the output shaft 11 drives the driving element 22 to rotate β clockwise, oscillating to the initial position of the driving element 22. In this process, the driving element 22 drives the first moving knife 23 to rotate clockwise around the pivoting shaft 262 through the fit between the first slot 227 and the first roller 235, and meanwhile drives the second moving knife 24 anticlockwise around the pivoting shaft 262 through the fit between the second slot 228 and the second roller 245, thus reducing the distance between the first head portion 231 and the second head portion 241 and finally increasing the included angle between the first cutting portion 232 and the second cutting portion 242 from α1 to α2.

As shown in FIG. 11, the output shaft 11 drives the driving element 22 to rotate β clockwise, oscillating to the clockwise limit position. In this process, the driving element 22 drives the first moving knife 23 to continuously rotate clockwise around the pivoting shaft 262 through the fit between the first slot 227 and the first roller 235, and meanwhile drives the second moving knife 24 continuously anticlockwise around the pivoting shaft 262 through the fit between the second slot 228 and the second roller 245, thus reducing the distance between the first head portion 231 and the second head portion 241 and finally increasing the included angle between the first cutting portion 232 and the second cutting portion 242 from α2 to α3.

Therefore, the included cutting angle between the first cutting knife 23 and the second cutting knife 24 increases from α1 to α3, thus completing the opening operation of the scissors accessory; on the contrary, when the driving element 22 rotates β anticlockwise, the included cutting angle between the first cutting knife 23 and the second cutting knife 2 decreases from α3 to α1, thus completing the closing operation of the scissors accessory. Repeatedly, the first cutting portion 232 of the first moving knife 23 reciprocatingly rotates relative to the second cutting portion 242 of the second moving knife 24, thereby realizing the object cutting function.

It should be pointed out that the present invention is not limited to the separated design of the cutting accessory and body disclosed in the above embodiment, in which the cutting accessory is installed on the body. Those skilled in this field can easily think that the cutting accessory of the present invention can also be integrated with the body through processing.

In the above embodiment, the casing of the output shaft is orthohexagonal, while the mounting portion of the driving element is dodecagonal, so the casing can be adapted to the mounting portion to realize that the output shaft can drive the driving element instead of generating relative sliding when reciprocatingly rotating, and meanwhile limit the driving element at many different angular positions according to demands. Those skilled in this field can think that the casing of the output shaft and the mounting portion of the driving element can also be combined in other way, for example, the mounting portion of the driving element is also processed to be orthohexagonal; the plural column-shaped projections on the output shaft are inserted into the corresponding holes on the driving element, or projections in other shapes (such as the star shape) on the output shaft are inserted into the holes in corresponding shapes on the driving element.

Compared with the prior art, the first embodiment of the present invention provides an oscillating power tool with a cutting accessory, wherein the output shaft drives the driving element to reciprocatingly rotate, and then the driving element drives the two moving knives to relatively reciprocatingly rotate so as to realize the cutting function. In the related art, the cutting accessory applied to the oscillating power tool realizes cutting through a movable blade and a fixed blade. Therefore, compared with the cutting accessory disclosed in the related art, the cutting accessory of the present invention can provide bigger cutting force and therefore greatly improves the cutting efficiency.

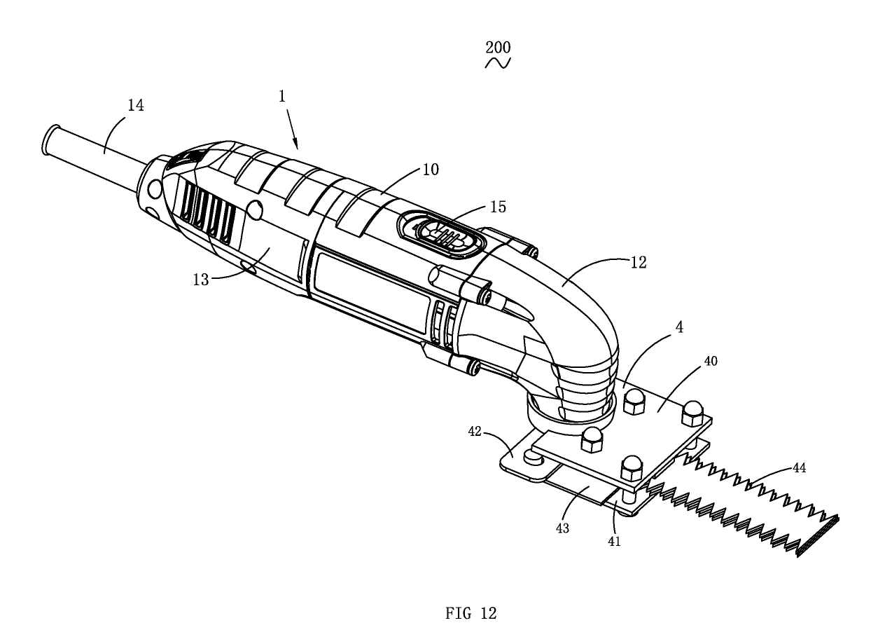

The following are detailed descriptions of the second embodiment of the present invention with reference to the FIGS. 12 to 17.

As shown in FIG. 12, the oscillating power tool 200 in this embodiment is identical with that in the first embodiment in the body 1, but different in the cutting accessory 4. The cutting accessory 4 is also detachably and separately designed. The cutting accessory 4 as an independent accessory is installed on the body 1 through the fastener 5. The cutting accessory 4 comprises an upper cover 40, a lower cover 41 adapted to the upper cover, a driving element 44 received between the upper and lower covers 40, 41, and a first moving knife 43 and a second moving knife 44 respectively connected to the driving element 42. The first and second moving knives 43, 44 are cascaded together and can reciprocatingly translate relative to the upper cover 40. With the cutting accessory 4 installed on the body 1, when the body 1 works, the motor drives the output shaft 11 to reciprocatingly rotate so as to drive the driving element 42 adapted to the output shaft 11 to reciprocatingly rotate, and then the driving element 42 drives the first moving knife 43 and the second moving knife 44 to relatively and reciprocatingly translate so as to realize the cutting function.

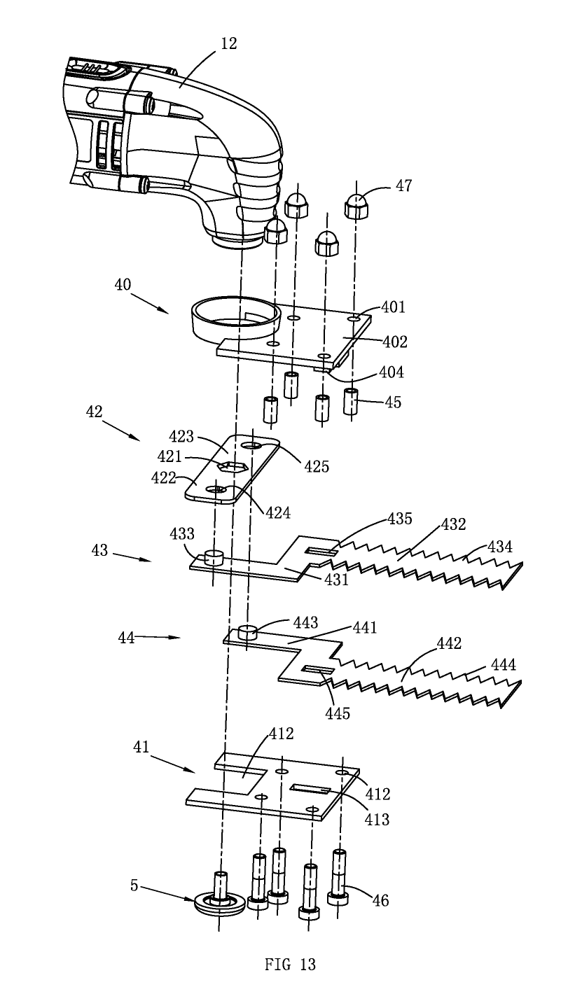

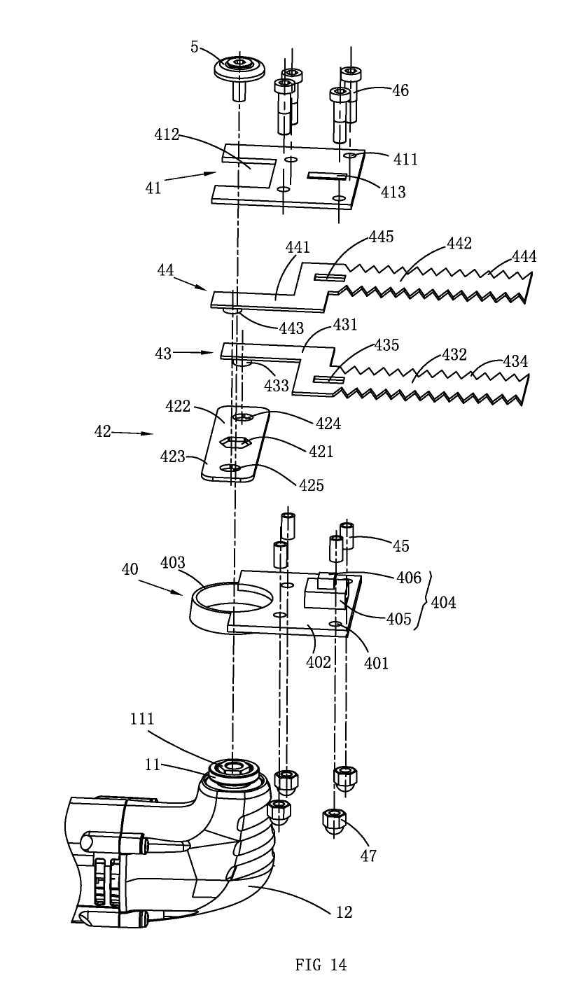

See FIG. 13 and FIG. 14. The structure of the cutting accessory 4 will be described in detail. The lower cover 41 is an approximately rectangular flat plate, provided with four througholes 411 in a scattered way. The upper cover 40 is also provided with four througholes 401 corresponding to the throughholes 411. Between the upper cover 40 and the lower cover 41 are four hollow supporting posts 45 located between the througholes 401 and the througholes 411. Four bolts 46 respectively pass through the throughholes 411 of the lower cover 41, the supporting posts 45 and the througholes 401 of the upper cover 40 and finally are fixed through four nuts, so the lower cover 41 and the upper cover 40 are fixed together. Through installing the supporting posts 45, a large enough space is formed between the upper and lower covers 40, 41 to receive the driving element 40 and the upper and lower moving knives 43, 44 and enable the upper and lower moving knives 43 to freely and reciprocatingly translate.

Wherein, the upper cover 40 comprises an approximately flat plate-shaped supporting element 402 and a fixing portion 403 on the supporting element 402. The plane where the supporting element 402 exists is vertical to the X-axis of the output shaft 11 and is approximately parallel to the lower cover 41. The fixing portion 403 is formed by extending from one side of the supporting element 402, approximately similar to the shape of the head housing 12, and just can be tightly sleeved on the head housing 12. One side, away from the head housing 12, of the supporting element 402 projects and extends to form a guide element 404 along the direction parallel to the X-axis of the output shaft 11. The guide element 404 is step-like, comprising a bigger first lug 405 and a smaller second lug 406. The two lugs both are cuboid shaped, wherein the second lug 406 extends from the middle portion of the first lug 405 and away from the output shaft 11.

The lower cover 41 is installed on the supporting element 402 of the upper cover 40, so the driving element 42, the first moving knife 43 and the second moving knife 44 are received in the space formed by the upper and lower covers 40, 41. One side of the lower cover 41 is provided with an opening 412 corresponding to the fixed portion 403 of the upper cover 40. The size of the opening 412 is bigger than the maximum outer diameter of the fastener 5, so the fastener 5 can penetrate through the opening 412 of the lower cover 41 to be adapted to the driving element 42. The other side of the lower cover 41, corresponding to the guide element 404 of the upper cover 40, is provided with a stop hole 413 capable of being sleeved on the second lug 406 of the guide element 404, so the first moving knife 43 and the second moving knife 44 are axially limited on the guide element 404 of the upper cover 40.

The two moving knives 43, 44 both are approximately flat plate shaped, and the plane where the two exist is vertical to the X-axis of the output shaft 11. The two moving knives 43 and 44 are symmetrically shaped, and extend lengthwise along the direction approximately vertical to the driving element 42. The first moving knife 43 has an approximately “L”-shaped first head portion 431 and a linear first cutting portion 432 vertically extending from the first head portion and away from one end of the driving element 42. The second moving knife 44 has a second head portion 441 shaped symmetric to the first head portion 431 of the first moving knife 43 and a second cutting portion 442 vertically extending from the second head portion 441 and away from one end of the driving element 42. One end, away from the first cutting portion 432, of the first head portion 431 of the first moving knife 43 is provided with a first roller 433 projecting towards the driving element 42; correspondingly, the second head portion 441 of the second moving knife 44 is provided with a second roller 443. The two moving knives 43, 44 are respectively connected to the driving element 42 through the first roller 433 and the second roller 443 so as to be driven by the driving element 42. The first cutting portion 432 of the first moving knife 43 and the second cutting portion 442 of the second moving knife 44 are superimposed together. The first cutting portion 432 and the second cutting portion 442 respectively extend towards two sides to form plural first cutting teeth 434 and second cutting teeth 444. The first cutting portion 432 and the second cutting portion 442 relatively and reciprocatingly translate, and then the opposite cutting teeth 434 and 444 perform cutting. The first cutting portion 432 of the first moving knife 43 is also provided with a first track 435 matched with the guide element 404 of the upper cover 40, and the second cutting portion 442 of the second moving knife 44 is correspondingly provided with a second track 445. The first track 435 and the second track 445 both are long strip-shaped openings, mutually run through and just have enough size to receive the second lug 406 of the guide element 404, so the second lug 406 can slide in the first track 435 and the second track 445.

It should be pointed out that, those skilled in this field can easily think that the first track and the second track in this embodiment can also be provided with projections, and correspondingly the guide element of the upper cover is formed with long strip-shaped openings by processing.

The driving element 42 is adapted to the output shaft 11 and driven by the output shaft 11 to actuate the two cutting knives 43, 44 to reciprocatingly translate so as to realize cutting operation. The driving element 42 is made of metal, approximately rectangular; the middle portion thereof is provided with a mounting portion 421 adapted to the casing 111 of the output shaft 11; and the two ends are symmetrically provided with a first driving portion 422 and a second driving portion 423. Wherein, the mounting portion 421 is an orthohexagonal opening, equivalent to the casing 111 of the output shaft 11 in size, and can just receive the casing 111. The first driving portion 422 is provided with a first groove 424, and the second driving portion 423 is correspondingly provided with a second groove 425. The central line of the two grooves passes through the centre of the mounting portion 421. The middle portion of the first groove 424 is provided with two parallel and opposite first straight sections 4241, while middle portion of the second groove 425 is also provided with two parallel and opposite second straight sections 4251. The first groove 424 is used for receiving the first roller 433 of the first moving knife 43, and the second groove 425 is used for receiving the second roller 443 of the second moving knife 44. The first groove 424 and the second groove 425 both are long waist-shaped, identical in size, and a little bigger than the first roller 433 and the second roller 443. The first roller 433 and the second roller 443 can respectively slide on the first groove 424 and the second groove 425.

In this embodiment, the assembly process of the cutting accessory 4 is as follows: first, place on the driving element 42 on the supporting element 402 of the upper cover 40; then, superpose and install the first moving knife 43 and the second moving knife 44 on the supporting element 402 of the upper cover 40 such that the first track 435 of the first moving knife 43 and the second track 445 of the second moving knife 44 are respectively sleeved on the second lug 406 of the guide element 404 of the upper cover 40; meanwhile, receive the first roller 433 of the first moving knife 43 in the first groove 424 of the driving element 42, receive the second roller 443 of the second moving knife 44 in the second groove 425 of the driving element 42; next, respectively place the four supporting posts 45 corresponding to the four througholes 401 on the supporting element 402 of the upper cover 40, fasten the lower cover 41 on the upper cover 40 such that the stop hole 413 of the lower cover 41 is sleeved on the guide element 404 of the upper cover 40; at last, respectively penetrate through four bolts 46 through the througholes 411 of the lower cover 41, the supporting posts 45 and the througholes 401 of the upper cover 40, and fix with nuts 47.

Through the above steps, the assembly of the cutting accessory 4 is completed. During use, the cutting accessory 4 is adapted to and fixed on the head housing 12 of the body 1, so the mounting portion 421 of the driving element 42 is adapted to the casing 111 of the output shaft 11, and the fastener 3 is connected to the thread hole 112 of the output shaft 11 to axially fix the driving element 42 relative to the output shaft 1. Therefore, the cutting accessory 4 is fixed with the body 1 and driven by the body 1 to realize the cutting function.

The following is the detailed description of the cutting principle of the cutting accessory 4 with reference to the FIGS. 12, 13, 15 to 17. The mounting portion 421 of the driving element 42 is adapted to the casing 111 of the output shaft 11. The first roller 433 on the first head portion 431 of the first moving knife 43 is received in the first groove 424 of the driving element 42. The second roller 443 on the second head portion 441 of the second moving knife 44 is received in the second groove 425 of the driving element 42. The first moving knife 43 and the second moving knife 44 can relatively and reciprocatingly translate and are crossly sleeved on the guide element 404 of the upper cover 40. When the oscillating power tool 200 works, the motor shaft of the body 1 drivers the output shaft 11 through the transmission mechanism to reciprocatingly rotate, and then the output shaft 11 drives the driving element 42 to reciprocatingly rotate through the fit between the casing 111 and the mounting portion 421 of the driving element 42. By the action of the guide element 404 of the upper cover 40, the driving element 42 drives the first moving knife 43 and the second moving knife 44 to relatively and reciprocatingly translate, so the cutting teeth 434, 444 of the first cutting portion 432 and the second cutting portion 442 perform cutting.

In this embodiment, the oscillating angle of the output shaft 11 of the oscillating power tool 200 is 2β, namely the value of the angle between the clockwise oscillating limit position and the anticlockwise oscillating limit position of the output shaft 11, wherein 2β=0.5°-10°, which means that the oscillating frequency of the output shaft 11 is 500-250,000 times/min Obviously, the oscillating angle and oscillating frequency of the oscillating power tool 200 in this embodiment are not limited in the above scope, and may be other numerical values.

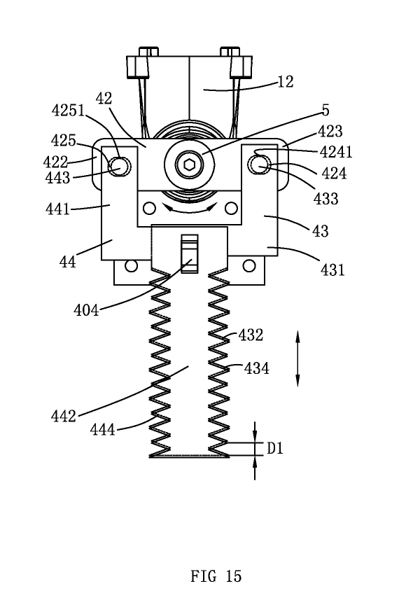

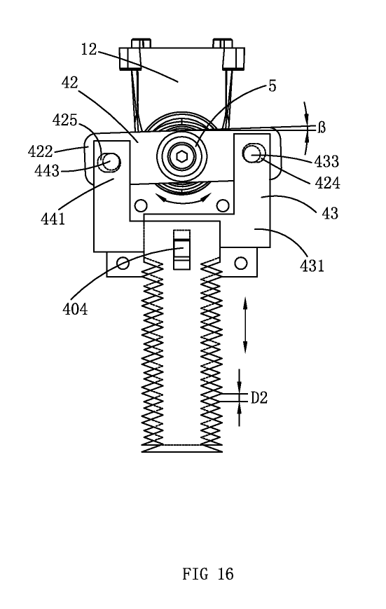

As shown in FIG. 15, the driving element 42 is located at an approximately level position; the first cutting portion 432 of the first moving knife 43 and the second cutting portion 442 of the second moving knife 44 are approximately superimposed; the distance between the adjacent cutting teeth 43, 44 in the vertical direction is D1.

As shown in FIG. 16, the output shaft 11 drives the driving element 42 to rotate β clockwise. In this process, through the fit between the first roller 433 and the first groove 424 and the guiding of the guide element 404 of the upper cover 40 and the first track 435, the driving element 42 drives the first moving knife 43 to vertically downward translate at a certain distance; meanwhile, through the fit between the second groove 425 and the second roller 443 and the guiding of the guide element 404 of the upper cover 40 and the second track 445, the driving element 42 drives the second moving knife 44 to vertically upward translate at a certain distance. This results in that the first cutting portion 432 and the second cutting portion 442 are staggered at a certain distance after reciprocating translation, and the distance between the cutting teeth 43, 44 in the vertical direction is decreased from D1 to D2, and thus, cutting of the object placed between the cutting teeth 43, 44, such as twigs, can be realized.

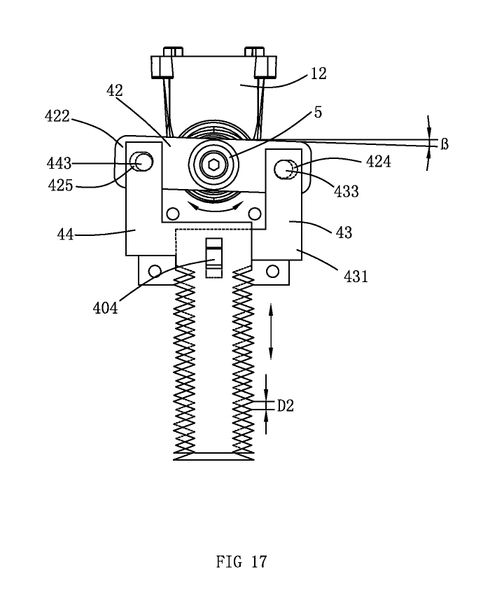

As shown in FIG. 17, contrary to that as shown in FIG. 16, the output shaft 11 drives the driving element 42 to rotate β anticlockwise, oscillating to the anticlockwise limit position. In this process, the driving element 42 drives the first moving knife 43 to vertically upward translate at a certain distance and meanwhile drives the second moving knife 44 to vertically downward translate at a certain distance, which results in that the first cutting portion 432 and the second cutting portion 442 are staggered at a certain distance after reciprocating translation, and that the distance between the cutting teeth 43, 44 in the vertical direction is decreased from D1 to D2, and thus, cutting of the object placed between the cutting teeth 43, 44, such as twigs, can be realized.

Compared with the prior art, this embodiment provides an oscillating power tool with a cutting accessory; the output shaft drives the driving element to reciprocatingly rotate; then the driving element drives the two moving knives to relatively and reciprocatingly translate so as to realize the cutting function. It can be used to prune plants in the garden, has high cutting efficiency than the common electric pruning shears, and therefore widens the application scope of the oscillation tool.

We claim:

1. A cutting accessory detachably mounted on an oscillating power tool, the oscillating power tool comprising a head housing and an output shaft protruding out of the head housing, the output shaft configured to rotate oscillatingly about a longitudinal axis thereof, the cutting accessory comprising a housing adapted to the head housing, two movable blades partly received in the housing, and a driving element adapted to the output shaft, the driving element configured to oscillate by the actuation of the output shaft and simultaneously drive the two movable blades to move in opposite directions to cut a workpiece.

2. The cutting accessory according to claim 1, wherein the driving element comprises a mounting portion adapted to the output shaft and two driving portions symmetrically disposed relative to the mounting portion, the two driving portions configured to adapt to the two movable blades respectively.

3. The cutting accessory according to claim 2, wherein in each pair of one driving portion and one movable blade, one of the driving portion and the movable blade comprises a groove and the other comprises a roller configured to be received and rolled in the groove.

4. The cutting accessory according to claim 3, wherein each groove comprises two straight sections which are located in the middle part of the groove and are parallel to each other.

5. The cutting accessory according to claim 4, wherein the angle of the straight sections of one of the grooves relative to the line of the centers of the grooves is different from the angle of the straight sections of the other groove relative to the line of the centers of the grooves.

6. The cutting accessory according to claim 3, wherein the grooves are formed at the driving portions respectively, and the centers of the two grooves and the center of mounting portion are located in a line.

7. The cutting accessory according to claim 3, wherein the two movable blades pivotably connect to the same pivoting shaft and the axis of the pivoting shaft is substantially parallel to the longitudinal axis of the output shaft.

8. The cutting accessory according to claim 7, wherein the centers of the rollers are equidistant from the center of the pivoting shaft.

9. The cutting accessory according to claim 1, wherein the housing comprises an upper cover and a lower cover adapted to the upper cover, the driving element and the movable blades disposed between the upper cover and the lower cover.

10. The cutting accessory according to claim 1, wherein the housing comprises an opening and a fixing portion adapted to the head housing, the output shaft configured to pass through the opening.

11. The cutting accessory according to claim 1, wherein the housing comprises a slot configured for receiving the driving element, and the driving element configured to rotate oscillatingly in the slot.

12. The cutting accessory according to claim 1, wherein the two movable blades each comprise a head portion, a cutting portion and a connecting portion between the head portion and the cutting portion, the head portions cooperating with the driving element respectively, the connecting portions pivotably connecting to the housing, the driving element configured to drive the cutting portions of the movable blades to move in the opposite directions.

13. The cutting accessory according to claim 1, further comprising a guide element fixed to the head housing, the movable blades each comprising a head portion cooperating with the driving element, a cutting portion and a guiding portion cooperating with the guide element, the cutting portions each having cutting teeth, the cutting teeth of the cutting portion of one of the movable blades being opposite to the cutting teeth of the cutting portion of the other movable blade, the driving element configured to drive the two movable blades to move in the opposite directions by the engagement of the guide element and the guide portion.

14. The cutting accessory according to claim 13, wherein the plane defined by the two movable blades is substantially perpendicular to the longitudinal axis of the output shaft and the cutting portions of the movable blades each comprise the cutting teeth at both sides thereof.

15. An oscillating power tool, comprising a head housing, an output shaft protruding out of the head housing and configured to rotate oscillatingly about a longitudinal axis thereof, and a cutting accessory mounted on the output shaft, the cutting accessory comprising two movable blades and a driving element adapted to the output shaft and configured to oscillate by the actuation of the output shaft and simultaneously drive the two movable blades to move in opposite directions to cut a workpiece.
